(19) United States
(12) Patent Application Publication
(10) Pub. No.: US 2026/0176147 A1
(43) Pub. Date: Jun. 25, 2026

(54) PRECIPITATED SILICA AND METHODS THEREOF

(71) Applicant: Evonik Operations GmbH, Essen (DE)

(72) Inventors: Fitzgerald A. Sinclair, Smyrna, DE (US); Michael S. Darsillo, Landenberg, PA (US); Karl W. Gallis, Perryville, MD (US); Terry W. Nassivera, Gambrills, MD (US); Eric G. Lundquist, Essex, MD (US)

(73) Assignee: Evonik Operations GmbH, Essen (DE)

(21) Appl. No.: 19/127,479

(22) PCT Filed: Nov. 8, 2023
(86) PCT No.: PCT/EP2023/081078

§ 371 Date: May 6, 2025

Related U.S. Application Data
(60) Provisional application No. 63/423,557, filed on Nov. 8, 2022.

(30) Foreign Application Priority Data
Nov. 30, 2022 (EP) 22210412.7

(51) Int. Cl. A61K 8/25; A61Q 11/00; C01B 33/18; C01B 33/193

(52) U.S. Cl. CPC C01B 33/193; A61Q 11/00; C01P 2004/03; C01P 2004/60; C01P 2006/11; C01P 2006/12; C01P 2006/17; C01P 2006/19

(57) ABSTRACT

The present disclosure relates to precipitated silicas having a mean primary particle size of greater than 80 nm, a BET surface area of less than 40 m²/g, and an oil absorption of above 160 cc/100 g. The silica is produced by a process that includes (a) dispersing colloidal seed particles ranging in primary particle size from 40-100 nm, preferably 50-80 nm, in water, (b) adding an electrolyte in a concentration of 2.5-4.0 wt.-% based on the total mass added in (a), (c) heating the suspension to 65-100° C., preferably 85-95° C., (d) adding an acid and silicate while maintaining a pH of between 7.5-10, preferably 8-9, for 60-180 minutes, (e) stopping the addition of silicate, (f) adding an acid until a pH of 3-6 is reached, (g) filtering, drying, and optionally milling. The precipitated silica is used in cosmetics, anti-caking free/flow, food, carrier applications, dentifrice, and mouthwash.

### TECHNICAL FIELD

The present disclosure relates generally to precipitated silica, and methods of making and using the same.

### BACKGROUND

Porous precipitated silicas are typically produced by the reaction of an alkaline silicate solution, e.g., sodium silicate, with a mineral acid. Commercially, sulfuric acid is mainly used, although other acids such as hydrochloric acid can be applied as well. The acid and the sodium silicate solution are added simultaneously with agitation to water. Precipitated silica arises when silica is precipitated from this dispersion by the neutralization reaction and the generation of by-product sodium salt (sodium sulfate). The precipitated silica consists of aggregates (secondary particles) of primary (or ultimate) colloidal silica particles. The primary particles are mostly spherical and usually have a diameter in the range between 5 and 50 nm. The primary particles in the aggregates are covalently bonded to one another by the formation of siloxane bonds. The aggregates are three-dimensional clusters of these primary particles. The aggregates have diameters of up to 500 nm. The aggregates are not chemically linked into a massive gel network during the preparation process. The aggregates themselves can be physically linked to larger agglomerates of up to 100 μm in diameter by the formation of hydrogen bonds between the silanol groups on their surfaces before milling. The median agglomerate size is about 20-50 μm in diameter (before milling). The porosity and surface area of these precipitated silica particles are a function of the size of the primary particles and how they aggregate and agglomerate. The pores are formed by the spaces between the primary particles, and the aggregates. Typical surface areas of commercial precipitated silicas are 5-800 m²/g. They are sold as powders. The tamped density, which is a measure of the weight of these porous powders, is in the range of 50-500 kg/m³. They have a high absorptive capacity of about 30-320 g/100 g.

U.S. Pat. No. 4,708,859 reports silicas with a CTAB of 20-120 m²/g, an oil adsorption of 250 to 500 ml/100 g and a projected area of greater than 8000 nm².

U.S. Pat. No. 8,597,425 reports that porous precipitated silicas with a primary particle size of 10-80 nm are useful in applications including rubber and tire, a battery separator, an antiblocking agent, a matting agent for inks and paints, a carrier for agricultural products and for feeds, a coating material, a printing ink, a fire-extinguisher powder, a plastic, in the non-impact printing sector, a paper pulp, or an article in the personal care sector,

It is reported in J. Soc Cosmet. Chem August 1978, 29, 497-521 that precipitated silicas with a primary particle size of 12-51 nm are useful in cosmetic applications including toothpaste.

A commercial product SIPERNAT® 22 useful in food and feed applications, as a carrier and anticaking-free flow additive is reported to have a primary particle size of 18 nm (Degussa literature No. 64, Physiological Behavior of highly dispersed Oxides of Silicon, Aluminum and Titanium 1978, page 26-27).

U.S. Pat. No. 6,946,119 discloses a precipitated silica product comprising silica particulate comprising silica particles having a median diameter of 1-100 micrometers that support surface deposits thereon comprising an active precipitated amorphous silica a material present in an amount effective to provide a BET specific surface area from 1-50 m²/g for the silica particulate. The precipitated silicas are used in oral care applications.

U.S. Pat. No. 7,255,852 describes a precipitated silica comprising silica product particles having a porous surface, the silica particles having a cumulative surface area for all pores having diameters greater than 500 A of less than 8 m²/g, as measured by mercury intrusion, a BET specific surface area of less than approximately 20 m²/g, and a percentage of cetylpyridinium chloride (% CPC) compatibility of greater than 55%. The precipitated silicas are used in oral care applications.

U.S. Pat. No. 7,438,895 discloses an abrasive precipitated silica material with a coating of precipitated silica thereon, wherein said coating of precipitated silica is denser than the material to which it is applied, and wherein said coated precipitated silica material exhibits a median particle size of between 5.5 and 8 microns, a pore area for pores with a diameter greater than 500 A of at most about 2.4 m²/g, and a percentage of cetylpyridinium chloride compatibility after aging said material for 7 days at 140° F. of at least 90%.

US20080160053 describes a method of manufacturing an abrasive silica material, wherein said method involves the following sequential steps: reacting, under high shear mixing conditions, a first amount of silicate and a first amount of acid together, optionally in the presence of at least one electrolyte present in an amount of 5 to 25% weight to weight basis in comparison with the dry weight of the first amount of said silicate, to form a first silica material; and reacting, in the presence of said first silica material, a second amount of silicate and a second amount of acid together, optionally in the presence of at least one electrolyte present in an amount of 5 to 25% weight to weight basis in comparison with the dry weight of the second amount of said silicate, to form a dense phase coating on the surface of said first silica material, thereby forming a silica-coated silica material; wherein said at least one electrolyte is present in either of said steps or during both steps, and wherein said second step is optionally performed under high shear mixing conditions.

U.S. Pat. No. 10,328,002 discloses a dentifrice composition comprising: an abrasive comprising precipitated silica particles characterized by; a BET surface area in a range from about 0.1 to about 9 m²/g; a pack density in a range from about 35 to about 55 lb/ft³; an Einlehner abrasion value in a range from about 8 to about 25 mg lost/100,000 revolutions; a total mercury intrusion pore volume in a range from about 0.4-1.2 cc/g; and a stannous compatibility in a range from about 70 to about 99%; wherein the abrasive comprises large pores of a size of approximately 1000 Angstroms or greater and lacks small pores sized less than approximately 500-1000 Angstroms.

WO 2018114280 describes silica particles with: a BET surface area in a range from about 0.1 to about 7 m²/g; a pack density in a range from about 35 to about 55 lb/ft³; an Einlehner abrasion value in a range from about 8 to about 25 mg lost/100,000 revolutions; a total mercury intrusion pore volume in a range from about 0.7 to about 1.2 cc/g; and a stannous compatibility in a range from about 70 to about 99%.

US20190374448 discloses a dentifrice composition comprising: binder; surfactant; silica particles; wherein the silica particles comprise: a d50 median particle size in a range from about 4 to about 25 μm; a BET surface area in a range from 0 to about 10 m²/g; and a total mercury intrusion pore volume in a range from about 0.2 to about 1.5 cc/g.

WO 2019238777 describes silica particles characterized by: (i) a d50 median particle size in a range from about 8 to about 20 μm; (ii) a sphericity factor (S80) of greater than or equal to about 0.9; (iii) a BET surface area in a range from about 0.1 to about 8 m²/g; (iv) a total mercury intrusion pore volume in a range from about 0.35 to about 0.8 cc/g; and (v) a loss on ignition (LOI) in a range from about 3 to about 7 wt. %.

EP 22160705.4 describes precipitated silica characterized by a primary particle size mean of greater than 80 nm, a BET surface area of 10-40 m²/g, a total mercury intruded volume of 0.75-2.00 cc/g, and an oil absorption of 60-120 cc/100 g.

U.S. Pat. No. 4,708,859 A describes precipitated silica characterized by a high oil absorption of greater than 300 cc/100 g with lower and higher BET surface areas. This US application does not provide the compatibility and viscosity data regarding silicas being used in toothpaste formulations.

The ability of precipitated silica to provide compatibility with ingredients while providing the correct balance of cleaning and abrasion is important in a toothpaste formulation. None of the prior art addresses the problem of lack of compatibility with other ingredients, like CPC and BAC, and flavor compatibility and to achieve PCR (80-110) and RDA (100-220) values in the normal range at the same time.

### SUMMARY

The inventors of the present invention have now found that silicas with high primary particle size can lead to high compatibility with CPC, BAC and/or flavor in oral care applications with acceptable viscosity build compared to traditional thickening silicas.

Subject of the invention is therefore precipitated silicas that are characterized by a mean primary particle size of greater than 80 nm, preferably greater than 100 nm, more preferably greater than 115 nm, most preferably between 115 nm and 130 nm, a BET surface area of less than 40 m²/g, preferably less than 35 m²/g, more preferably less than 30 m²/g, most preferably between 15 m²/g and 30 m²/g, and an oil absorption of above 160 cc/100 g, preferably above 175 cc/100 g more preferably above 200 cc/100 g, most preferably between 200 cc/100 g and 250 cc/100 g.

Subject of the invention is also a process comprising
(a) dispersing colloidal seed particles ranging in primary particle size from 40-100 nm in water,
(b) adding of an electrolyte in a concentration of 2.5-4.0 wt.-% based on the total mass added in step (a)
(c) heating the suspension to 65-100° C.,
(d) adding of acid and silicate while maintaining a pH of between 7.5-10, for a time of 60-180 minutes,
(e) stopping the addition of silicate,
(f) adding of acid until a pH of 3-6 is reached,
(g) filtering, drying and optionally milling.

A further subject of the invention is the use of the inventive silicas in cosmetics, anti-caking free/flow, food, carrier applications, dentifrice and mouthwash.

A further subject of the invention is an oral care comprising the inventive silica.

### DETAILED DESCRIPTION OF THE INVENTION

The inventive precipitated silicas have a mean primary particle size of greater than 80 nm, preferably greater than 100 nm, more preferably greater than 115 nm, most preferably between 115 nm and 130 nm, a BET surface area of less than 40 m²/g, preferably less than 35 m²/g, more preferably less than 30 m²/g, most preferably between 15 m²/g and 30 m²/g, and an oil absorption of above 160 cc/100 g, preferably above 175 cc/100 g, more preferably above 200 cc/100 g, most preferably between 200 cc/100 g and 250 cc/100 g.

The precipitated silica according to the invention is characterized by a mean primary particle size (a) of 80 nm≤(a)≤140 nm, preferably 110 nm≤(a)≤140 nm, a BET surface area (b) of less than 40 m²/g, preferably less than 27 m²/g and an oil absorption (c) of 160 cc/100 g≤(c)≤250 cc/100 g.

The precipitated silica according to the invention could have a total mercury intruded volume of 2.5 cc/g-5.3 cc/g, preferably 3.0-5.3 cc/g, more preferably 4.0-5.3 cc/g.

The precipitated silica according to the invention could have a CTAB surface area of lower than 40 m²/g, preferably lower than 35 m²/g, more preferably lower than 30 m²/g.

The precipitated silica according to the invention could have a pack density of <0.32 g/cm³, preferably 0.11-0.24 g/cm³.

The precipitated silica according to the invention could have a mean primary particle size of 100-125 nm, a BET surface area of 15-30 m²/g, a total mercury intruded volume of 2.5-5.3 cc/g and an oil absorption of 200-250 cc/100 g.

The precipitated silica according to the invention could have a mean primary particle size of greater than 80 nm, a BET surface area of 10-40 m²/g, a total mercury intruded volume of 2.5-5.3 cc/g and an oil absorption of 175-250 cc/100 g.

The precipitated silica according to the invention could have a mean primary particle size of greater than 100 nm, a BET surface area of 10-26 m²/g, a total mercury intruded volume of 2.5-5.3 cc/g and an oil absorption of 175-250 cc/100 g.

The precipitated silica according to the invention could have a mean primary particle size of greater than 100 nm, a BET surface area of 10-23 m²/g, a total mercury intruded volume of 2.5-5.3 cc/g and an oil absorption of 175-250 cc/100 g.

The precipitated silica according to the invention could have a mean primary particle size of greater than 80 nm, a BET surface area of 10-30 m²/g, a total mercury intruded volume of 2.5-5.3 cc/g and an oil absorption of 175-250 cc/100 g.

The precipitated silica according to the invention could have a mean primary particle size of greater than 100 nm, a BET surface area of 10-23 m²/g, a total mercury intruded volume of 2.5-5.3 cc/g and an oil absorption of 175-250 cc/100 g.

The precipitated silica according to the invention could have a mean primary particle size of 120-135 nm, a BET surface area of 10-20 m²/g, a total mercury intruded volume of 2.5-5.3 cc/g and an oil absorption of 175-250 cc/100 g.

The precipitated silica according to the invention could have a mean primary particle size of greater than 100 nm, a BET surface area of 10-30 m²/g, a total mercury intruded volume of 2.5-5.3 cc/g and an oil absorption of 175-250 cc/100 g.

The precipitated silica according to the invention could have a mean primary particle size of 120-135 nm, a BET surface area of 10-20 m²/g, a total mercury intruded volume of 2.5-5.3 cc/g and an oil absorption of 175-250 cc/100 g.

The precipitated silica according to the invention could have a mean primary particle size (a) of 85 nm≤(a)≤100 nm, a BET surface area of 10-35 m²/g, a total mercury intruded volume of 2.5-5.3 cc/g and an oil absorption of 170-250 cc/100 g.

The process according to the invention comprises at least the following steps:
(a) dispersing colloidal seed particles ranging in primary particle size from 40-100 nm, preferably 50-80 nm, in water,
(b) adding of an electrolyte in a concentration of 2.5-4.0 wt.-% based on the total mass of colloidal seed particles added in step (a)
(c) heating the suspension to 65-100° C., preferably 85-95° C.,
(d) adding of acid and silicate while maintaining a pH of between 7.5-10, preferably 8-9, for a time of 60-180 minutes
(e) stopping the addition of silicate,
(f) adding of acid until a pH of 3-6 is reached,
(g) filtering, drying and optionally milling.

The filtering in step (g) could be done in a filter press, rotary vacuum filter, belt filter or the like.

The drying in step (g) could be done in a spray dryer, flash dryer or the like.

The milling in step (g) could be done in an impact mill, such as Raymond mill, air jet mill or the like.

The colloidal seed particles in step (a) could be 40-100 nm, such as Nexsil from Nyacol Nano Technologies, Inc; AmSol from Applied Material Solutions, Inc; Levasil by Nouryon; Snowtex by Nissan Chemical).

The dispersing in step (a) can be done in a baffled reactor with agitation sufficient to keep particles dispersed.

The temperature range in step (a) could be 20-95° C., preferably 40-95° C., preferably 60-85° C., more preferably 70-80° C.

The colloidal seed particles in the step (a) could be used in an amount of 0.15-5 wt % based on the total volume added in step (a). The colloidal silica can represent 5-10% of the total silica product produced in this process-steps (a) to (g).

The silicate rate in step (d) could be 0.5-2.2% of the total volume of silicate added/minute of the total volume of silicate added.

The alkali metal silicate in step (d) could be preferably earth alkaline silicate or alkali metal silicate, more preferably sodium silicate.

The acid in step (d) and (f) could be preferably sulfuric acid.

The period of time for step (d) could be 60-180 minutes, preferably 90-120 minutes.

During step (d) additional electrolyte can be added in an amount of 1.8-5.0% based on the starting water volume.

The electrolyte in step (b) could be alkali metal salt, preferably sodium or potassium salts of sulfate, chloride, and the like.

The inventive precipitated silica can be produced by the inventive process.

The inventive precipitated silica could be used in cosmetics, anti-caking free/flow, food, carrier applications, dentifrice and mouthwash.

Oral care composition comprising the inventive precipitated silica.

The inventive oral care composition can comprise a second precipitated silica with a primary particle size mean of greater than 80 nm, a BET surface area of 10-40 m²/g, a total mercury intruded volume of 0.75-2.00 cc/g and an oil absorption of 60-120 cc/100 g.

The inventive oral care composition can comprise a second silica with a BET surface area of less than 5 m²/g.

The inventive precipitated silicas have an improved compatibility with cetylpyridinium chloride (CPC), benzalkonium chloride (BAC) and flavor while providing acceptable rheology in oral care applications.

### Mean Primary Particle Size by SEM

Images were taken by scanning electron microscopy at a magnification of 50,000 times. The images were sputtered with platinum and care was taken so the sputtering did not cause texturing of the particles surface, as this could be mistaken for primary structure. The image must be representative of the entire sample and contain a minimum of 30 particles. The primary particles were then measured. If the particles were not completely round, the smallest diameter across each particle was used. Particles that are on the edges of the image that cannot be completely observed should not be used. Mean and median values were then calculated based on the data set.

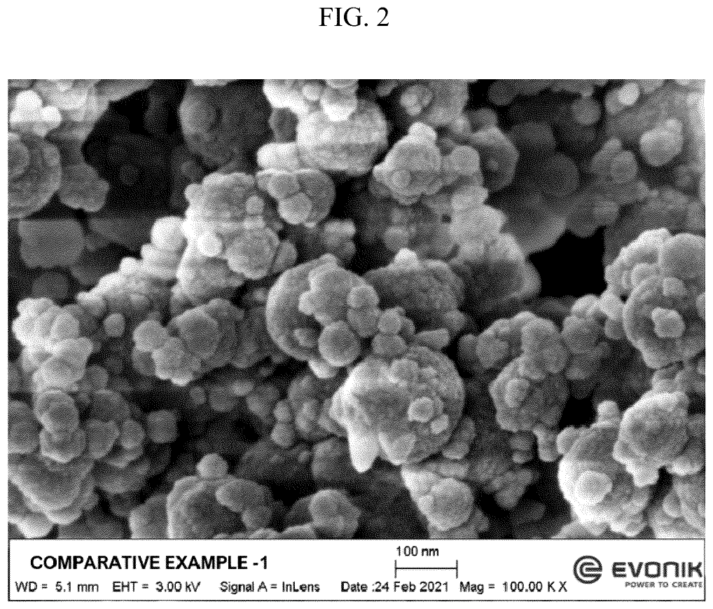

FIG. 2 shows a SEM Image of comparative Example 1.

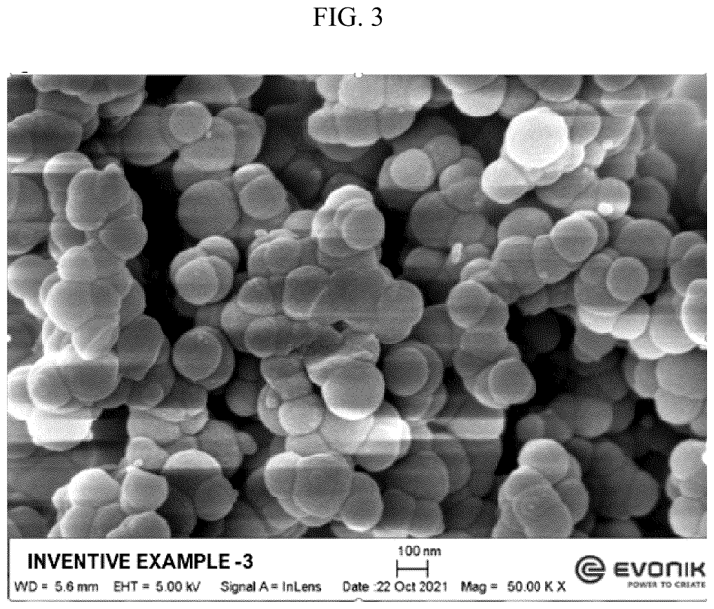

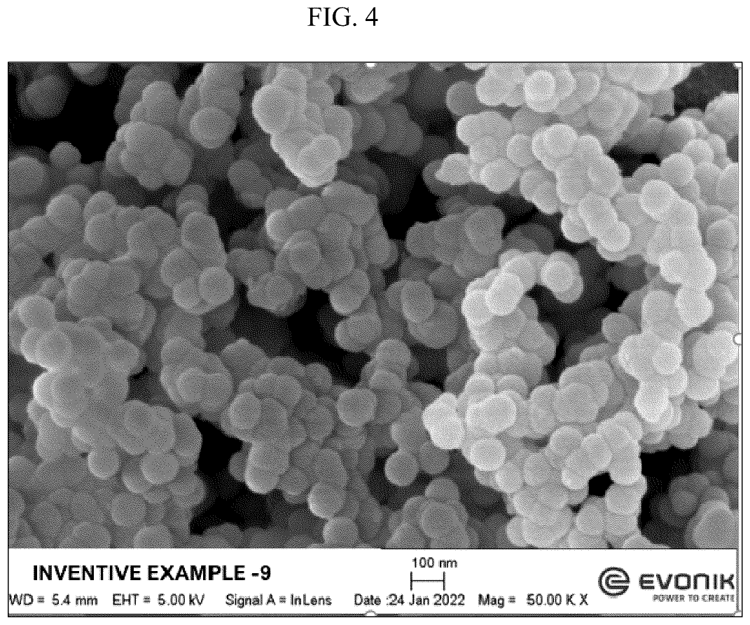

FIGS. 3 and 4 show SEM Image of inventive Examples 3 and 9.

### Brightness

Silica samples were pressed into a smooth surfaced pellet and analyzed using a Technidyne Brightmeter S-5/BC. This instrument has a dual beam optical system where the sample is illuminated at an angle of 45°, and the reflected light is viewed at 0°. It conforms to TAPPI test methods T452 and T646, and ASTM Standard D985. Powdered materials are pressed to about a 1 cm pellet with enough pressure to give a pellet surface that is smooth and without loose particles or gloss.

### Moisture

The moisture was determined by heating the silica at 105° C. for 2 hours. The moisture is the loss of weight in percent according to the undried silica.

### BET Surface Area

The BET surface areas of silicas of the invention were determined with a Micromeritics TriStar 3020 instrument by the BET nitrogen adsorption method of Brunaur et al., J. Am. Chem. Soc., 60, 309 (1938), which is known in the field of particulate materials, such as silica and silicate materials.

### Oil Absorption

Oil absorption values were determined in accordance with the rub-out method described in ASTM D281 using linseed oil (cc oil absorbed per 100 g of the particles). Generally, a higher oil absorption level indicates a higher structure particle, while a lower value typically indicates a lower structure particle.

### Total Mercury Intrusion Volume

Mercury intruded volume or total pore volume (Hg) was measured by mercury porosimetry using a Micromeritics AutoPore IV 9520 (or, Micromeritics AutoPore V 9620) apparatus. The pore diameters was calculated by the Washburn equation employing a contact angle Theta (θ) equal to 130° and a surface tension gamma equal to 484 dynes/cm. Mercury was forced into the voids of the particles as a function of pressure and the volume of the mercury intruded per gram of sample was calculated at each pressure setting. Total pore volume expressed herein represents the cumulative volume of mercury intruded at pressures from vacuum to 60,000 psi. Increments in volume (cm³/g) at each pressure setting were plotted against the pore radius or diameter corresponding to the pressure setting increments. The peak in the intruded volume versus pore radius or diameter curve corresponds to the mode in the pore size distribution and identifies the most common pore size in the sample. Specifically, sample size was adjusted to achieve a stem volume of 25-90% in a powder penetrometer with a 5 mL bulb and a stem volume of about 1.1 mL. Samples were evacuated to a pressure of 50 μm of Hg and held for 5 minutes. Mercury filled the pores from 4.0 to 60,000 psi with a 10 second equilibrium time at each data collection point). The total pore volume as described above captures the volumes from intraparticle porosity resulting from the pore structure within the individual particles, as well as, the interparticle porosity formed from the interstitial spacing of the packed particles under pressure.

### CTAB Surface Area

The CTAB surface areas disclosed herein were determined by absorption of CTAB (cetyltrimethylammonium bromide) on the silica surface, the excess separated by centrifugation and the quantity determined by titration with sodium lauryl sulfate using a surfactant electrode. Specifically, about 0.5 grams of the silica particles were placed in a 250-mL beaker with 100 mL CTAB solution (5.5 g/L), mixed on an electric stir plate for 1 hour, then centrifuged for 30 min at 10,000 RPM. One mL of 10% Triton X-100 was added to 5 mL of the clear supernatant in a 100-mL beaker. The pH was adjusted to 3-3.5 with 0.1 N HCl and the specimen was titrated with 0.01 M sodium lauryl sulfate using a surfactant electrode (Brinkmann SUR1501-DL) to determine the endpoint.

### Particle Size

Measurement of the particle size of the silicas of the invention was conducted on HORIBA Laser Scattering Dry Particle Size Distribution Analyzer LA-960 through the angle of scattered laser light.

### Water Corrected AbC Value

Water absorption values were determined with an Absorptometer “C” torque rheometer from C.W. Brabender Instruments, Inc. Approximately ⅓ of a cup of the silica sample was transferred to the mixing chamber of the Absorptometer and mixed at 150 RPM. Water was then added at a rate of 6 mL/min, and the torque required to mix the powder was recorded. As water was absorbed by the powder, the torque reached a maximum as the powder transformed from free-flowing to a paste. The total volume of water added when the maximum torque was reached is then standardized to the quantity of water that could be absorbed by 100 g of powder. Since the powder was used on an as received basis (not previously dried), the free moisture value of the powder was used to calculate a “moisture corrected water AbC value” by the following equation.

$$Water Corrected AbC Value = \frac{water absorbed ( cc ) + \% moisture}{( 100 ( g ) - \% moisture ) / 100}$$

5 wt. % pH

5% pH was measured by weighing 5.0 g of sample out to the nearest 0.1 g and transferring the weighed sample to a 250 mL beaker. 95 mL of DI water was added and the sample was stirred for 5 min. The pH was then measured with the pH meter while the sample was being stirred.

### Pack Density and Pour Density

Pack density and pour density were measured by placing 20.0 g of the sample into a 250 mL graduated cylinder with a flat rubber bottom. The initial volume was recorded and used to calculate the pour density by dividing it into the weight of sample used. The cylinder was then placed onto a tap density machine where it was rotated on a cam at a specific RPM. The cam was designed to raise and drop the cylinder a distance of 5.715 cm once per second, until the sample volume was constant, typically for 15 min. This final volume was recorded and used to calculate the packed density by dividing it into the weight of sample used.

### EXAMPLES

### Comparative Example 1

4000 mL of water and 60.0 g of NexSil 125-40 (80 nm colloidal silica, 40% by volume) were added to an 8 L reaction vessel and was stirred at 350 rpm with a temperature of 98° C. Approximately 5 mL of 50% sodium hydroxide was added to adjust the pH of the solution to 10.0. Thereafter sodium silicate (3.3MR 19.5%) was added at 12 mL/min and sulfuric acid (17.1%) was added at a rate sufficient to maintain a pH of 9.80-9.95. After 150 minutes, the flow of silicate was stopped and sulfuric acid was added at 2.0 mL/min until pH 9.4 was reached. Once pH 9.4 was reached, the batch was filtered and washed with 4 L of deionized water and was dried overnight at 125° C.

The analytical results are described in Table 1.

TABLE 1

| | Unit | Comparison Example 1 |
|---|---|---|
| AbC | cc/100 g | 171.6 |
| BET | m²/g | 26 |
| CTAB | m²/g | 25 |
| Pack density | g/cm³ | 0.285 |
| Pour density | g/cm³ | 0.218 |
| Mean Particle | μm | 14.3 |
| size | | |
| Median | μm | 13.1 |
| Particle size | | |
| Na2SO4 | % | 2.52 |
| Na2SO4, | μmhos/cm | 2000 |
| Conductivity | | |
| Oil absorption | Cc/100 g | 148 |
| pH 5% | | 11.0 |
| Mean primary | nm | 50 |
| particle size | | |

### Comparative Example 2

4000 mL of water and 60.0 g of NexSil 125-40 (80 nm colloidal silica, 40% by volume) were added to an 8 L reaction vessel and was stirred at 350 rpm with a temperature of 98° C. Approximately 5 mL of 50% sodium hydroxide was added to adjust the pH of the solution to 10.0. Thereafter sodium silicate (3.3MR 19.5%) was added at 3 mL/min and sulfuric acid (17.1%) was added at a rate sufficient to maintain a pH of 9.80-9.95. After 600 minutes, the flow of silicate was stopped and sulfuric acid was added at 2.0 mL/min until pH 9.4 was reached. Once pH 9.4 was reached, the batch was filtered and washed with 4 L of deionized water and was dried overnight at 125° C.

The analytical results are described in Table 2.

TABLE 2

| | Unit | Comparison Example 2 |
|---|---|---|
| BET | m²/g | 16 |
| CTAB | m²/g | 16 |
| Mean Particle | μm | 9.7 |
| size | | |
| Median | μm | 8.9 |
| Particle size | | |
| Oil absorption | Cc/100 g | 84 |
| pH 5% | | 10.9 |
| Mean primary | nm | 140 |
| particle size | | |

### Comparative Example 3

4000 mL of water and 60.0 g of NexSil 125-40 (80 nm colloidal silica, 40% by volume) were added to an 8 L reaction vessel and was stirred at 350 rpm with a temperature of 98° C. Approximately 5 mL of 50% sodium hydroxide was added to adjust the pH of the solution to 10.0. Thereafter water and sodium silicate (3.3MR 19.5%) were added at 6 mL/min and 6 mL/min, respectively. Sulfuric acid (17.1%) was added at a rate sufficient to maintain a pH of 9.80-9.95. After 256 minutes, the flow of silicate was stopped and sulfuric acid was added at 2.0 mL/min until pH 5.7 was reached. Once pH 5.7 was reached, the batch was filtered and washed with 4 L of deionized water and was dried overnight at 125° C.

The analytical results are described in Table 3.

TABLE 3

| | Unit | Comparison Example 3 |
|---|---|---|
| AbC | | 161 |
| BET | m²/g | 48 |
| CTAB | m²/g | 42 |
| Pack density | g/cm³ | 0.203 |
| Pour density | g/cm³ | 0.096 |
| Mean Particle | μm | 7.8 |
| size | | |
| Median | μm | 7.3 |
| Particle size | | |
| Na2SO4 | % | <0.69 |
| Na2SO4, | μmhos/cm | 134 |
| Conductivity | | |
| Oil absorption | Cc/100 g | 139 |
| pH 5% | | 7.7 |
| Mean primary | nm | 85 |
| particle size | | |

### Inventive Example 1

5508 mL of water, 100.0 g of NexSil 125-40 (80 nm colloidal silica, 40% by volume), and 192.5 g of sodium sulfate were added to an 8 L reaction vessel and was stirred at 350 rpm with a temperature of 95° C. Sodium silicate (3.3MR 19.5%) was added at 6 mL/min and sulfuric acid (17.1%) was added at a rate sufficient to maintain a pH of 9.5-9.9. After 180 minutes, the flow of silicate was stopped and sulfuric acid was added at 2.0 mL/min until pH 5.5 was reached. Once pH 5.5 was reached, the batch was filtered and washed with 4 L of deionized water and was dried overnight at 125° C.

The analytical results are described in Table 4.

TABLE 4

| | Unit | Inventive Example 1 |
|---|---|---|
| AbC | cc/100 g | 200.9 |
| BET | m²/g | 13 |
| CTAB | m²/g | 7 |
| Pack density | g/cm³ | 0.37 |
| Pour density | g/cm³ | 0.24 |
| Mean Particle | μm | 18.6 |
| size | | |
| Median | μm | 16.7 |
| Particle size | | |
| Na2SO4 | % | <0.69 |
| Na2SO4, | μmhos/cm | 135 |
| Conductivity | | |
| Oil absorption | Cc/100 g | 191 |
| pH 5% | | 7.26 |
| Mean primary | nm | 120 |
| particle size | | |

### Comparative Examples 4-5 and Inventive Example 2-3

5508 mL of water, 100.0 g of NexSil 125-40 (80 nm colloidal silica, 40% by volume), and sodium sulfate (see Table 5) were added to an 8 L reaction vessel and was stirred at 350 rpm with a temperature of 95° C. Sodium silicate (2.5MR 20.0%) was added at 6 mL/min and sulfuric acid (17.1%) was added at a rate sufficient to maintain a pH of 9.5-9.9. After 120 minutes, the flow of silicate was stopped and sulfuric acid was added at 2.0 mL/min until pH 5.5 was reached. Once pH 5.5 was reached, the batch was filtered and washed with 4 L of deionized water and was dried overnight at 125° C. 10

TABLE 5

| | Sodium sulfate | Initial |
|---|---|---|
| Example# | added (g) | Conductivity (uS/cm2) |
| Comp. Ex. 4 | 50 | 2500 |
| Comp. Ex. 5 | 100 | 4840 |
| Inv. Ex. 2 | 150 | 6240 |
| Inv. Ex. 3 | 200 | 7100 |

The analytical results are described in Table 6.

TABLE 6

| | | Compar- | Compar- | Inven- | Inven- |
|---|---|---|---|---|---|
| | | ative | ative | tive | tive |
| | | Exam- | Exam- | Exam- | Exam- |
| | Unit | ple 4 | ple 5 | ple 2 | ple 3 |
| AbC | cc/100 g | 75.3 | 138.8 | 189.1 | 237.4 |
| BET | m²/g | 26 | 20 | 18 | 12 |
| CTAB | m²/g | 34 | 46 | 22 | 15 |
| Pack density | g/cm³ | 0.59 | 0.32 | 0.28 | 0.41 |
| Pour density | g/cm³ | 0.45 | 0.20 | 0.18 | 0.21 |
| Mean | μm | 61.2 | 12.0 | 11.0 | 10.7 |
| Particle size | | | | | |
| Median | μm | 42.3 | 7.7 | 10.5 | 10.2 |
| Particle size | | | | | |
| Na2SO4 | Wt.-% | <0.69 | <0.69 | <0.69 | <0.69 |
| Na2SO4, | μmhos/cm | 291 | 512 | 549 | 41 |
| Conductivity | | | | | |
| Oil | Cc/100 g | 64 | 142 | 193 | 209 |
| absorption | | | | | |
| pH 5% | | 8.3 | 8.4 | 6.5 | 7.9 |
| Mean | nm | 105 | 105 | 110 | 120 |
| primary | | | | | |
| particle size | | | | | |
| Mean | (nm²) | — | — | — | 213,775 |
| projected | | | | | |
| area of | | | | | |
| aggregates | | | | | |

### Inventive Example 4-6

5000 mL of water, NexSil 125-40 (80 nm colloidal silica, 40% by volume)—see Table 7, and 200 g of sodium sulfate were added to an 8 L reaction vessel and was stirred at 350 rpm with a temperature of 95° C. Sodium silicate (2.5MR 20.0%) was added at 6 mL/min and sulfuric acid (17.1%) was added at a rate sufficient to maintain a pH of 9.5-9.9. After 120 minutes, the flow of silicate was stopped and sulfuric acid was added at 2.0 mL/min until pH 5.5 was reached. Once pH 5.5 was reached, the batch was filtered and washed with 4 L of deionized water and was dried overnight at 125° C.

TABLE 7

| | NexSil 125-40 |
|---|---|
| Inventive | (80 nm colloidal |
| Example# | silica) added (g) |
| 4 | 25 |
| 5 | 50 |
| 6 | 100 |

The analytical results are described in Table 8.

TABLE 8

| | | Inventive | Inventive | Inventive |
|---|---|---|---|---|
| | Unit | Example 4 | Example 5 | Example 6 |
| AbC | cc/100 g | 166.1 | 185.2 | 237.4 |
| BET | m²/g | 9 | 8 | 12 |
| CTAB | m²/g | 16 | 17 | 15 |
| Pack density | g/cm³ | 0.370 | 0.384 | 0.408 |
| Pour density | g/cm³ | 0.250 | 0.263 | 0.213 |
| Mean Particle | μm | 13.4 | 13.7 | 10.7 |
| size | | | | |
| Median | μm | 12.9 | 13.3 | 10.2 |
| Particle size | | | | |
| Na2SO4 | % | <0.69 | <0.69 | <0.69 |
| Na2SO4, | μmhos/cm | 31 | 215 | 41 |
| Conductivity | | | | |
| Oil absorption | Cc/100 g | 161 | 170 | 209 |
| pH 5% | | 7.6 | 6.8 | 7.9 |
| Mean primary | nm | 110 | 140 | 120 |
| particle size | | | | |
| Mean | (nm²) | — | 407,620 | — |
| projected | | | | |
| area of | | | | |
| aggregates | | | | |

### Inventive Example 7-9

Water, Silbond VPS XK-NF 60 (60 nm colloidal silica, 20.7% solids, and sodium sulfate (see Table 9) were added to an 8 L reaction vessel and was stirred at 350 rpm with a temperature of 95° C. Sodium silicate (2.5MR 20.0%) was added at 12 mL/min and sulfuric acid (17.1%) was added at a rate sufficient to maintain a pH of 8.4-8.7. After the time specified in Table 9, the flow of silicate was stopped and sulfuric acid was added at 2.0 mL/min until pH 5.5 was reached. Once pH 5.5 was reached, the batch was filtered and washed with 4 L of deionized water and was dried overnight at 125° C. 10

TABLE 9

| | | | Coaddition | |
|---|---|---|---|---|
| | | | (primary | |
| | Silbond VPS XK- | Volume of | particle size | Na2SO4 |
| Inventive | NF 60 added | dilution | growth time) | added |
| Example# | (g) | water | minutes | (g) |
| 7 | 100 | 3000 | 60 | 90 |
| 8 | 100 | 2000 | 60 | 60 |
| 9 | 100 | 4000 | 90 | 120 |

The analytical results are described in Table 10. The chemical and physical characteristics of ZEODENT® 165 and 153 is provided in the same table as well.

TABLE 10

| | | Inventive | Inventive | Inventive | ZEO- | ZEO- | SIPER- |
|---|---|---|---|---|---|---|---|
| | Unit | Example 7 | Example 8 | Example 9 | DENT ® 153 | DENT ® 165 | NAT ® 50 |
| AbC | | 207.3 | 237.2 | 222.7 | 191 | 260 | — |
| BET | m²/g | 33 | 26 | 28 | 117 | 136 | 502 |
| CTAB | m²/g | 45 | 42 | 43 | 116 | 132 | — |
| Pack | g/cm³ | 0.17 | 0.23 | 0.20 | 14.9 | 12.5 | — |
| density | | | | | | | |
| Pour | g/cm³ | 0.09 | 0.26 | 0.11 | 8.9 | 6.9 | — |
| density | | | | | | | |
| Mean | μm | 6.2 | 15.4 | 15.7 | 11.7 | 13.8 | — |
| Particle | | | | | | | |
| size | | | | | | | |
| Median | μm | 5.8 | 13.1 | 13.5 | 10.7 | 12.3 | — |
| Particle | | | | | | | |
| size | | | | | | | |
| Na2SO4 | % | 2.78 | <0.69 | 1.41 | — | — | — |
| Na2SO4, | μmhos/ | 2220 | 452 | 1127 | — | — | — |
| Conductivity | cm | | | | | | |
| Oil | Cc/100 g | 172 | 219 | 200 | 166 | 219 | 309 |
| absorption | | | | | | | |
| pH 5% | | 5.6 | 6.1 | 5.6 | 7.0 | 7.2 | — |
| Mean | nm | 85 | 85 | 100 | 25 | 19 | 5 |
| primary | | | | | | | |
| particle | | | | | | | |
| size | | | | | | | |
| Mean | (nm2) | — | — | 189,225 | — | — | — |
| projected | | | | | | | |
| area of | | | | | | | |
| aggregates | | | | | | | |

According to the present invention, desired compatibility can only be achieved with reduced BET SA and increased primary particle size together with an oil absorption range. Very high oil absorption values would not provide the desired compatibility since it is technically not likely possible to provide a high oil absorption silica with a very low BET SA without increasing the primary particle size of the silicas to >80 nm. BET SA and oil absorption values are related and typically run in parallel with one another; when one increases the other does as well. It is not possible to separate these parameters to such an extent by conventional synthesis techniques.

According to the present invention the process involves (1) a solution of colloidal silica particles of the correct size (preferably 45-85 nm), (2) adding a sodium sulfate and water to the solution of colloidal silica primary particles and (3) carefully adding sodium silicate and sulfuric acid at the appropriate conditions to grow the primary particles to >80 nm. This primary particle growth reduces BET SA and also strengthens the primary aggregates in order to provide structural integrity to the particles to allow for a sufficient viscosity build in toothpaste. This level of aggregate reinforcement can be measured by the mean projected area of the aggregates, as the inventive examples ranged from approximately 189,000 to 480,000 nm².

### Example 10: BAC

### BAC Titration:

To determine a given silicas capacity for a quaternary ammonium compound, a zeta potential titration was conducted. In the titration, a 5 wt. % suspension of the desired silica was made by taking the desired amount of dry silica and diluting to 160 g with de-ionized water. In order to get as close to the desired 5 wt. % (8 g) of silica in the 160 g suspension, the amount of as received silica used was adjusted to compensate for the amount of free moisture (loss on drying) and sodium sulfate present. This suspension was magnetically stirred at 500 rpm for 10 minutes to allow the silica to fully wet out then the suspensions were adjusted to a pH of ˜8.5 with either 0.5M NaOH or 0.5M HCl, to help with consistency of the initial surface chemistry and a more direct comparison.

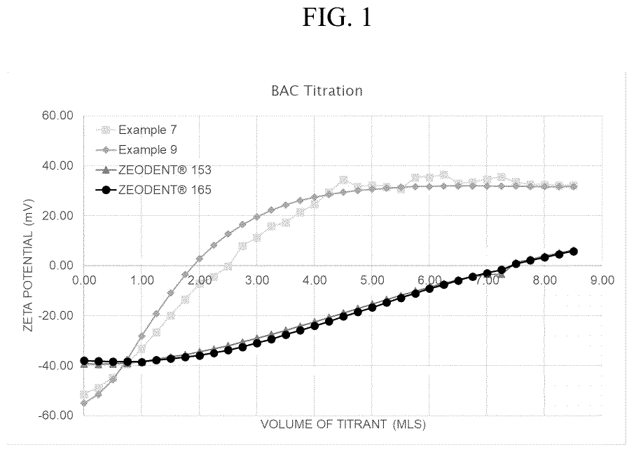

Compared to a classical toothpaste thickener silica of similar oil absorption (Zeodent 153 and Zeodent 165) or higher oil absorption (Sipernat 50) the inventive silicas of example 7 and 9 required significantly less BAC (benz alkonium chloride) to cross the “0” saturation point (Table 11, FIG. 1). This would indicate a more favorable compatibility to cationic surfactants despite the higher oil absorption and viscosity building capability. This is attributed to the greatly reduced surface area afforded by the aggregation of the larger primary particle size.

The BAC compatibility of Zeodent 153, Zeodent 165, SIPERNAT® 50 and further two of the inventive silicas (3 and 5) in addition to inventive examples 7 and 9 shown below in Table 11.

TABLE 11

| Sample | Quantity of BAC to 0 mV (mL) |
|---|---|
| ZEODENT ® 153 | 7.5 |
| ZEODENT ® 165 | 7.5 |
| SIPERNAT ® 50 | 12.25 |
| Inventive Example 7 | 2.5 |
| Inventive Example 9 | 1.8 |
| Inventive Example 3 | 1.25 |
| Inventive Example 5 | 0.75 |

### Example 11: Flavor

Method: 500 mg of silica was placed in a headspace vial. 10 μl of flavor (Lime Oil, Lot MKCF9356 flavor matrix) was added and the vial was allowed to equilibrate overnight. The samples were incubated at 60° C. for 60 minutes with gentle shaking before the headspace was sampled. 1 mL of head space was analyzed in a GC/MS with equipped with a Stabilwax column (0.25 mm×60 m) with a column flow rate of 1.606 mL/min and a temperature ramp of 6° C./min over a temperature range of 40° C. to 230° C. (HS Sampling: 1 mL of the head space was sampled into a gas tight syringe at 65 C). Peak areas were standardized relative to the peak intensity for ZEODENT® 165.

The results are shown in Table 12.

TABLE 12

| | | | Inven- | Inven- | Inven- |
|---|---|---|---|---|---|
| | ZEO- | ZEO- | tive | tive | tive |
| | DENT ® | DENT ® | Exam- | Exam- | Exam- |
| Sample | 165 | 153 | ple 7 | ple 8 | ple 9 |
| α-pinene | 1.00 | 1.06 | 1.70 | 1.79 | 1.77 |
| β-pinene | 1.00 | 0.97 | 1.88 | 2.22 | 1.88 |
| β-myrcene | 1.00 | 1.14 | 2.17 | 2.84 | 2.49 |
| α-terpinene | 1.00 | 0.63 | 0.63 | 1.39 | 1.45 |
| limonene | 1.00 | 1.14 | 2.13 | 2.18 | 2.18 |
| eucalyptol | 1.00 | 1.03 | 1.74 | 3.49 | 3.18 |
| γ-terpinene | 1.00 | 1.01 | 0.33 | 0.80 | 0.37 |
| o-cymene | 1.00 | 1.28 | 8.01 | 8.06 | 9.12 |
| terpinolene | 1.00 | 0.96 | 0.36 | 0.85 | 0.43 |
| dehydro-p- | 1.00 | 1.16 | 2.35 | 3.31 | 2.75 |
| cymene | | | | | |
| Sum of ratio | 10.00 | 10.38 | 21.31 | 26.92 | 25.62 |

The high pore volume inventive silicas were incorporated into a standard toothpaste formula to judge their performance at viscosity build in the toothpaste (Table 13).

TABLE 13

| Example | 11A | 11B | 11C |
|---|---|---|---|
| Sorbitol, 70.0% | 49.520 | 49.520 | 49.520 |
| Glycerin, 99.5% | 5.850 | 5.850 | 5.850 |
| Deionized Water | Q.S. | Q.S. | Q.S. |
| Propylene Glycol | 2.500 | 2.500 | 2.500 |
| CMC, Cekol 2000 | 0.950 | 0.950 | 0.950 |
| Xanthan gum, Keldent | 0.100 | 0.100 | 0.100 |
| Sodium Fluoride | 0.210 | 0.210 | 0.210 |
| Sodium Saccharin | 0.200 | 0.200 | 0.200 |
| Blue #1 1.00% Soln | 0.030 | 0.030 | 0.030 |
| ZEODENT ® 103 | 6.000 | 6.000 | 6.000 |
| ZEODENT ® 153 | 12.000 | | |
| Inventive Example 7 | | 12.000 | |
| Inventive Example 9 | | | 12.000 |
| Titanium Dioxide | 0.500 | 0.500 | 0.500 |
| Total | 100.000 | 100.000 | 100.000 |

They were compared to standard ZEODENT® 153 and the viscosities measured through 9 weeks. The results are shown in Table 14.

TABLE 14

| | 1 week | 3 week | 6 week | 9 week |
|---|---|---|---|---|
| | viscosity | viscosity | viscosity | viscosity |
| | 25° C. | 25° C. | 25° C. | 25° C. |
| | (×10K) | (×10K) | (×10K) | (×10K) |
| Toothpaste | (cP) | (cP) | (cP) | (cP) |
| Example 11A | 49.5 | 56.8 | 57.6 | 58.8 |
| Example 11B | 60.7 | 71.7 | 67.7 | 67.9 |
| Example 11C | 49.2 | 58.2 | 62.3 | 63.1 |

### Example 12: Free Flow Food Application

### Loose Bulk Density

Samples were poured through a funnel into a previously tared 100 ml graduated cylinder until the cylinder overflowed. The excess sample was gently scraped away and weight of the cylinder/sample was determined. The weight of the sample was then divided by its volume to calculate the density. Samples with an increased loose bulk density value typically exhibit improved flow characteristics, since the particles are “less sticky” and can pack together more efficiently in a given space.

### Pressure/Heat/Moisture Caking

Pressure, heat and moisture caking is a test used to determine a powders tendency to clump together and form lumps (or a cake) when subjected to pressure, heat and/or moisture, either from processing, packaging, shipping or storage. A sample of 5.0 g was loaded into an aluminum tray and a previously determined condition was applied to it. The resulting cake was then transferred to a 12 mesh sieve and vibrated for 1 minute. The remaining cake was then weighed and recorded as a percentage of the original 5.0 g sample.

### Flodex Flowability Index

A Flodex is an instrument designed to evaluate the flow of a powder through an orifice, such as the conditions experienced when a silo is emptied. The orifice size in the instrument is gradually reduced until the powder will no longer flow through. The smaller the orifice size, the better the flow ability of the powder. The Flodex Powder Flowability tester was from Teledyne Hansen, Chatsworth, CA.

The studies conducted to gauge the efficacy of the inventive silicas in retarding caking and how they impact flow properties of these model systems. What was important was that at least maintained comparable performance to a standard anti caking free flow agent (Sipernat®22S) is possible. However what was observed was that the inventive examples worked very well in a salt and sweet whey system to prevent caking, similarly to the Sipernat®22S. In the two food systems the maximum allowable loading permissible in food (2%) was used. It became evident that it is possible to use even lower loadings of the conditioning agents (Table 15+16).

TABLE 15

| | | Loose | |
|---|---|---|---|
| Sweet Whey | Anti- | Bulk | Flodex |
| Heat | Caking | Density | Flow |
| (65° C. for 60 min) | % cake | (g/mL) | Index |
| UNCONDITIONED | 66.09 | 55.94 | 22 |
| 2.0% SIPERNAT ® 22S | 6.96 | 65.15 | 7 |
| 2.0% ZEODENT ® 113 | 11.64 | 66.99 | 4 |
| 2.0% Inventive Example 7 | 1.45 | 62.48 | 8 |
| 2.0% Inventive Example 8 | 0.79 | 61.50 | 12 |
| 2.0% Inventive Example 9 | 1.37 | 61.61 | 14 |

TABLE 16

| Salt | | Loose | |
|---|---|---|---|
| Moisture & Pressure | Anti- | Bulk | Flodex |
| (0.33 g/50 g) | Caking | Density | Flow |
| (2.0 psi for 15 min) | % cake | (g/mL) | Index |
| UNCONDITIONED | 85.08 | 1.1202 | 6 |
| 2.0% SIPERNAT ® 22S | 0.10 | 1.0798 | 4 |
| 2.0% ZEODENT ® 113 | 1.20 | 1.1309 | 6 |
| 2.0% Inventive Example 7 | 0.16 | 1.0975 | 4 |
| 2.0% Inventive Example 8 | 0.23 | 1.0860 | 4 |
| 2.0% Inventive Example 9 | 0.17 | 1.0427 | 7 |

1. A precipitated silica comprising a mean primary particle size (a) of 80 nm≤(a)≤140 nm, a BET surface area (b) of less than 40 m²/g, and an oil absorption (c) of 160 cc/100 g≤(c)≤250 cc/100 g.

2. The precipitated silica according to claim 1, wherein the BET surface area (b) is 8≤(b)≤35 m²/g.

3. The precipitated silica according to claim 1, wherein the precipitated silica has a CTAB surface area of lower than 40 m²/g.

4. The precipitated silica according to claim 1, wherein the precipitated silica has a pack density of <0.32 g/cm³.

5. The precipitated silica of claim 1, wherein the precipitated silica has a mean primary particle size of 100-125 nm, a BET surface area of 15-30 m²/g, a total mercury intruded volume of 2.5-5.3 cc/g, and an oil absorption of 200-250 cc/100 g.

6. The precipitated silica of claim 1, wherein the precipitated silica has a mean primary particle size (a) of 110 nm≤(a)≤140 nm, a BET surface area of 10-40 m²/g, a total mercury intruded volume of 2.5-5.3 cc/g, and an oil absorption of 175-250 cc/100 g.

7. The precipitated silica of claim 1, wherein the precipitated silica has a mean primary particle size (a) of 110 nm≤(a)≤140 nm, a BET surface area of 10-26 m²/g, a total mercury intruded volume of 2.5-5.3 cc/g, and an oil absorption of 175-250 cc/100 g.

8. The precipitated silica of claim 1, wherein the precipitated silica has a mean primary particle size (a) of 85 nm≤(a)≤100 nm, a BET surface area of 10-35 m²/g, a total mercury intruded volume of 2.5-5.3 cc/g, and an oil absorption of 170-250 cc/100 g.

9. A process for the production of a precipitated silica comprising:
(a) dispersing colloidal seed particles ranging in primary particle size from 40-100 nm in water,
(b) adding an electrolyte in a concentration of 2.5-4.0 wt.-% based on the total mass of colloidal seed particles added in (a),
(c) heating a suspension to 65-100° C.,
(d) adding an acid and silicate while maintaining a pH of between 7.5-10 for 60-180 minutes,
(e) stopping the addition of silicate,
(f) adding an acid until a pH of 3-6 is reached,
(g) filtering, drying, and optionally milling,
wherein the silica comprises a mean primary particle size a) of 80 nm≤a)≤140 nm, a BET surface area b) of less than 40 m²/g, and an oil absorption c) of 250 cc/100 g≥c)≥160 cc/100 g.

10. The process for the production of the precipitated silica of claim 9, wherein the temperature range in (a) is 40-95° C.

11. The process for the production of the precipitated silica of claim 9, wherein the colloidal seed particles in (a) are in an amount of 0.15-5 wt % based on the total volume added in (a).

12. The process for the production of the precipitated silica of claim 9, wherein the silicate adding rate in (d) is 0.5-2.2% of the total volume of the silicate added/minute of the total volume of the silicate added.

13. The process for the production of the precipitated silica of claim 9, wherein the silicate in (d) is earth alkaline silicate or alkali metal silicate and the acid in (d) and (f) is sulfuric acid.

14. The process for the production of the precipitated silica of claim 9, wherein the electrolyte in (b) is an alkali metal salt.

15. A method, comprising:
utilizing the precipitated silica of claim 1 in at least one member selected from the group consisting of cosmetics, anti-caking free/flow, food, carrier applications, dentifrice, and mouthwash.

16. An oral care composition comprising the precipitated silica of claim 1.

17. The oral care composition of claim 16, comprising a second precipitated silica with a primary particle size mean of greater than 80 nm, a BET surface area of 10-40 m²/g, a total mercury intruded volume of 0.75-2.00 cc/g, and an oil absorption of 60-120 cc/100 g.

18. The oral care composition of claim 16, comprising a second silica with a BET surface area of less than 5 m²/g.
